(19) United States
(12) Patent Application Publication
(10) Pub. No.: US 2012/0330442 A1
(43) Pub. Date: Dec. 27, 2012

(54) DEVICE FOR CONTROLLING WASHING MACHINE AND CONTROL METHOD THEREOF

(75) Inventors: Jin-Seong Hwang, Geumcheon-Gu (KR); Jun-Young Lim, Geumcheon-Gu (KR); Mun-Seok Seo, Geumcheon-Gu (KR)

(73) Assignee: LG ELECTRONICS INC., Yeoungdeungpo-gu-Seoul (KR)

(21) Appl. No.: 13/391,980

(22) PCT Filed: Jan. 15, 2010
(86) PCT No.: PCT/KR10/00262

§ 371 Date: Sep. 5, 2012

(51) Int. Cl. G06F 19/00

(52) U.S. Cl. 700/90

(57) ABSTRACT

Disclosed is a control apparatus and method of a clothes treating machine. Power consumption can be expected or detected when an operation of the clothes treating apparatus is determined, and greenhouse gas emissions to an energy source or electricity prices according can be expected on the basis of power consumption. In addition, reasonable operations can be determined on the basis of recommended operation conditions provided by the clothes treating apparatus, and power consumption of the clothes treating machine, greenhouse gas emissions to an energy source or electricity prices can be easily calculated without providing an additional complicated power detection circuit.

### TECHNICAL FIELD

The present invention relates to a control apparatus and method of a clothes treating machine, and particularly, to a control apparatus and method of a clothes treating machine that estimates or detects power consumption of the clothes treating machine, calculates expected greenhouse gas emissions and electricity prices of an energy source supplying power to the clothes treating machine on the basis of power consumption, and provides a user with information about energy saving.

### BACKGROUND ART

In general, a clothes treating machine refers to a washing machine designed to wash an dry fibers or a clothes dryer designed only to dry fibers. A washing machine is mainly used to remove dirt from fibers received in a drum through a washing process. At the same time, the washing machine also removes odor from the fibers. A washing machine with a drying function may dry fibers having gone through the washing process. A clothes dryer supplies hot air into a drum in which fibers are received in order to perform a drying process of the fibers received in the drum.

In general, the clothes treating machine as described above has a plurality of display devices in order to display washing or drying time during the washing process or the drying process, operating information of the current clothes treating machine, information sensed by various internal and external sensing devices, or various types of information input by a user through an input unit that is provided in the clothes treating machine.

As such a clothes treating machine consumes electrical energy, users are concerned about power consumption and electricity prices. Recently, with the rising of energy consumption, development of more energy sources and energy development have been required. However, greenhouse gas emissions have increased in line with energy development, which has pushed environmental issues including global warming on the agenda. In addition, in order to reduce greenhouse gas emissions, particularly, carbon dioxide emissions, alternative energy sources such as wind power, solar light, solar heat, geothermal power, tidal power, and hydropower as well as nuclear power and fuel cells have been developed.

In the related art, since power consumption of a clothes treating machine is measured by a watt hour meter that measures the entire amount of electric energy consumed within a house, it is difficult to know individual power consumption of the clothes treating machine. As a result, a user cannot check power consumption of each home appliance such as a clothes treating machine, greenhouse gas emissions of energy sources, and electricity prices.

In addition, when it comes to using a clothes treating machine according to the related art, a user cannot obtain information about the operating state of the clothes treating machine and energy saving according to operating situations, which may lead to reduction of utilization efficiency of the clothes treating machine.

Moreover, a control apparatus and method according to the related art cannot deal with environmental issues since it does not take greenhouse gas emissions from energy sources generating energy into account,

### DISCLOSURE OF THE INVENTION

Therefore, an object of the present invention is to provide a control apparatus and method of a clothes treating machine that estimates or calculates estimated power consumption of the clothes treating machine on the basis of information about operations determined in the clothes treating machine and sensed laundry weight, calculates expected greenhouse gas emissions according to an energy source and electricity prices, and provides energy-saving tips to consume minimum power or reduce greenhouse gas emissions so that a user re-determines the determined operations.

An aspect of the present invention also provides a control apparatus and method of a clothes treating machine that detects states of operating loads according to information about operations determined in the clothes treating machine, and estimates or calculates expected power consumption of the clothes treating machine, and corrects the expected power consumption on the basis of load amount of variable loads when the detected loads are the variable loads.

An aspect of the present invention also provides a control apparatus and method of a clothes treating machine that that visually displays power consumption according to operation of the clothes treating machine, greenhouse gas emissions according to an energy source, or electricity prices to a user, so that a consumer can reasonably determine operations with respect to power consumption according to the use of the clothes treating machine, greenhouse gases, or electricity prices in consideration of energy saving.

An aspect of the present invention also provides a control apparatus and method of a clothes treating machine that detects actual power consumption individually used by the clothes treating machine in real time or accumulates the actual power consumption, and provides a user with power consumption, greenhouse gas emissions, electricity prices, and use time.

To achieve these and other advantages and in accordance with the purpose of the present invention, as embodied and broadly described herein, there is provided a control apparatus of a clothes treating machine, the control apparatus including: a manipulation unit determining an operation to be performed by the clothes treating machine or re-determining an operation determined beforehand; a controller calculating expected power consumption according to the operation determined or re-determined; and a display unit displaying the expected power consumption or corresponding greenhouse gas emissions or both the expected power consumption and the greenhouse gas emissions.

The controller may further calculate electricity prices on the basis of the expected power consumption, and the display unit may further display the electricity prices.

The controller may create at least one message including energy-saving tips or recommended operation conditions according to operation of the clothes treating machine on the basis of at least one piece of information including the operation, the expected power consumption, the electricity prices, and the greenhouse gas emissions, and the display unit may further display the message.

The control apparatus may further include a storage unit storing at least one of the operation, the expected power consumption, the electricity prices, the greenhouse gas emissions, and the message.

The control apparatus may further include a communication unit receiving a kind of an energy source generating input power and a greenhouse gas index according to the energy source and sending the message.

The control apparatus of claim may further include: a sensing unit sensing at least one piece of information including laundry weight, water supply temperature, operating states of loads, and variations of the loads; and an electric energy detection unit connected to an input power source and detecting supplied power input to the clothes treating machine.

According to another aspect of the present invention, there is provided a control apparatus of a clothes treating machine, the control apparatus including: a sensing unit sensing at least one piece of information including laundry weight, water supply temperature, operating states of loads, and variations of the loads; a controller calculating expected power consumption according to the information sensed; and a display unit displaying the expected power consumption or corresponding greenhouse gas emissions or both the expected power consumption and the corresponding greenhouse gas emissions.

The controller may further calculate electricity prices on the basis of the expected power consumption, and the display unit may further display the electricity prices.

The controller may create at least one message including energy-saving tips or recommended operation conditions according to operation of the clothes treating machine on the basis of at least one piece of information including the sensed information, the expected power consumption, the electricity prices, and the greenhouse gas emissions, and the display unit may further display the message.

The control apparatus may further include a manipulation unit determining an operation to be performed by the clothes treating machine or re-determining an operation determined beforehand.

The control apparatus may further include an electric energy detection unit connected to an input power source and detecting supplied power input to the clothes treating machine.

The sensing unit includes: a speed sensing unit sensing a speed of a motor; and a thermal mass sensing unit sensing thermal mass of a heater.

The controller corrects the expected power consumption on the basis of the variations of the loads.

According to another aspect of the present invention, there is provided a control apparatus of a clothes treating machine, the control apparatus including: an electric energy detection unit connected to an input power source and detecting supplied power input to the clothes treating machine; a controller calculating greenhouse gas emissions or electricity prices on the basis of the supplied power; and a display unit displaying at least one of the supplied power, the greenhouse gas emissions, and the electricity prices.

The controller may create at least one message including energy-saving tips or recommended operation conditions according to operation of the clothes treating machine on the basis of at least one piece of information including the supplied power, the electricity prices, and the greenhouse gas emissions, and the display unit may further display the message.

The control apparatus may further include a storage unit storing at least one of the supplied power, the electricity prices, the greenhouse gas emissions, and the message.

The control apparatus may further include a communication unit receiving a kind of an energy source generating input power and a greenhouse gas index according to the energy source and sending the message.

The control apparatus may further include: a sensing unit sensing at least one piece of information including laundry weight, water supply temperature, operating states of loads, and variations of the loads; and a manipulation unit determining an operation to be performed by the clothes treating machine or re-determining an operation determined beforehand.

According to another aspect of the present invention, there is provided a control method of a clothes treating machine, the control method including: calculating expected power consumption on the basis of an operation to be performed by the clothes treating machine or at least one piece of sensed information including laundry weight, water supply temperature, operating states of loads, and variations of the loads or detecting supplied power input to the clothes treating machine to display the expected power consumption or the supplied power; and calculating electricity prices or greenhouse gas emissions on the basis of the expected power consumption or the supplied power to further display the electricity prices or the greenhouse gas emissions.

The control method may further include creating at least one message including energy-saving tips or recommended operation conditions according to operation of the clothes treating machine on the basis of at least one of the expected power consumption or the supplied power, the electricity prices, the greenhouse gas emissions, the operation, and the sensed information, and further displaying the message.

The control method may include receiving an operation to be performed by the clothes treating machine, and displaying estimated power consumption according to the operation.

The control method may include sensing at least one piece of information including laundry weight, water supply temperature, operating states of loads, and variations of the loads; and displaying expected power consumption according to the sensed information.

The control method may further include calculating expected power consumption according to the determined operation or the sensed information. In addition, the control method may further include detecting supplied power input to the clothes treating machine.

The control method may further include calculating electricity prices on the basis of the expected power consumption or the supplied power. In addition, the control method may further include calculating greenhouse gas emissions of an energy source supplying power to the clothes treating machine on the basis of the expected power consumption or the supplied power.

The control method may further include creating at least one message including energy-saving tips or recommended operation conditions according to operation of the clothes treating machine on the basis of at least one of the expected power consumption or the supplied power, the electricity prices, the greenhouse gas emissions, the determined operation, and the sensed information. In addition, the control method may further include display at least one of the expected power consumption or the supplied power, the electricity prices, the greenhouse gas emissions of the energy source, the determined operation, the sensed information, and the message. In addition, the control method may further include displaying whether to re-determine the determined operation when the discrepancy between the determined operation and the recommended operation conditions exceeds a predetermined range.

The calculating of the electricity prices may be reading electricity prices corresponding to the expected power consumption or the supplied power from a database storing electricity prices with respect to power consumption in advance.

The control method may further include correcting the expected power consumption on the basis of the variations of the loads.

According to the apparatus and method for controlling the clothes treating machine according to exemplary embodiments of the present invention, expected power consumption or supplied power of the clothes treating machine is detected on the basis of information about operations determined in the clothes treating machine and sensed laundry weight, calculates expected greenhouse gas emissions according to an energy source and electricity prices, and provides energy-saving tips to consume minimum power, so that power consumption, greenhouse gas emissions, or electricity prices can be easily guided to a user without using an electric power meter or a complicated power detection circuit and the user can re-determine the operations of a washing machine for efficient power consumption.

According to the apparatus and method for controlling the clothes treating machine according to exemplary embodiments of the present invention, states of operating loads are detected according to information about operations determine in the clothes treating machine to calculate expected power consumption of the clothes treating machine or detect supplied power, and the expected power consumption is corrected on the basis of load amount of variable loads when the detected loads are the variable loads, so that power consumption, greenhouse gas emissions, or electricity prices can be easily guided to a user without using an electric power meter or a complicated power detection circuit and power consumed by a washing machine can be more accurately predicted.

According to the apparatus and method for controlling the clothes treating machine according to exemplary embodiments of the present invention, power consumption, greenhouse gas emissions or electricity prices according to operation of the clothes treating machine are visually displayed to a user, so that a user can reasonably determine operations with respect to power consumption according to the use of the clothes treating machine, greenhouse gas emissions, or electricity prices in consideration of energy saving.

According to the apparatus and method for controlling the clothes treating machine according to exemplary embodiments of the present invention, actual power consumption individually used by the clothes treating machine is detected in real time or is accumulated to provide user with power consumption, greenhouse gas emissions, electricity prices, and use time, and information about energy saving, allowing the user to actively save energy.

### BRIEF DESCRIPTION OF THE DRAWING

FIG. 1 is a perspective view illustrating a steam jet drum washing machine, which is one example of a clothes treating machine to which the present invention is applied;

FIG. 2 is a lateral cross-sectional view illustrating the internal structure of the steam jet drum washing machine of FIG. 1 in detail;

FIG. 3 is a block diagram illustrating a control apparatus of a clothes treating machine according to an exemplary embodiment of the present invention;

FIG. 4 is a block diagram illustrating a control apparatus of a clothes treating machine according to another exemplary embodiment of the present invention;

FIG. 5 is a flowchart illustrating a control method of a clothes treating machine according to an exemplary embodiment of the present invention;

FIG. 6 is a flowchart illustrating a control method of a clothes treating machine according to another exemplary embodiment of the present invention;

FIG. 7 is a diagram illustrating determined operations, recommended operation conditions, and electricity prices according to expected power consumption and power consumption shown on a display unit of a control apparatus according to an exemplary embodiment of the present invention;

FIG. 8 is a flowchart illustrating a control method of a clothes treating machine according to another exemplary embodiment of the present invention;

FIG. 9 is a diagram illustrating determined operations, recommended operation conditions, and electricity prices according to expected power consumption and power consumption shown on a display unit of a control apparatus according to another exemplary embodiment of the present invention;

FIG. 10 is a schematic view illustrating the structure of a ductless dryer, which is one example of a clothes treating machine to which the present invention is applied; and

FIG. 11 is a schematic view illustrating the structure of a top load washing machine, which is one example of a clothes treating machine to which the present invention is applied.

### MODES FOR CARRYING OUT THE PREFERRED EMBODIMENTS

Reference will now be made in detail to the preferred embodiments of the present invention, examples of which are illustrated in corresponding drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of the configuration and operation according to an embodiment, with reference to corresponding drawings.

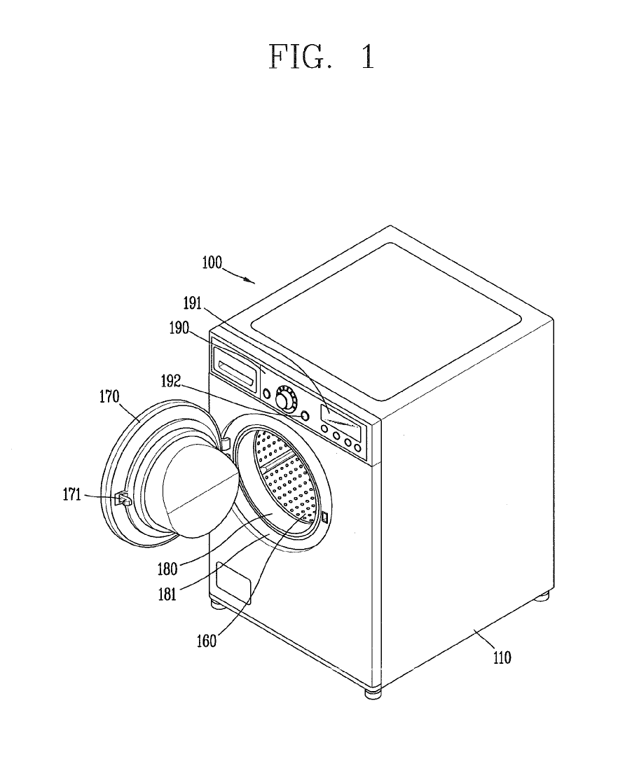

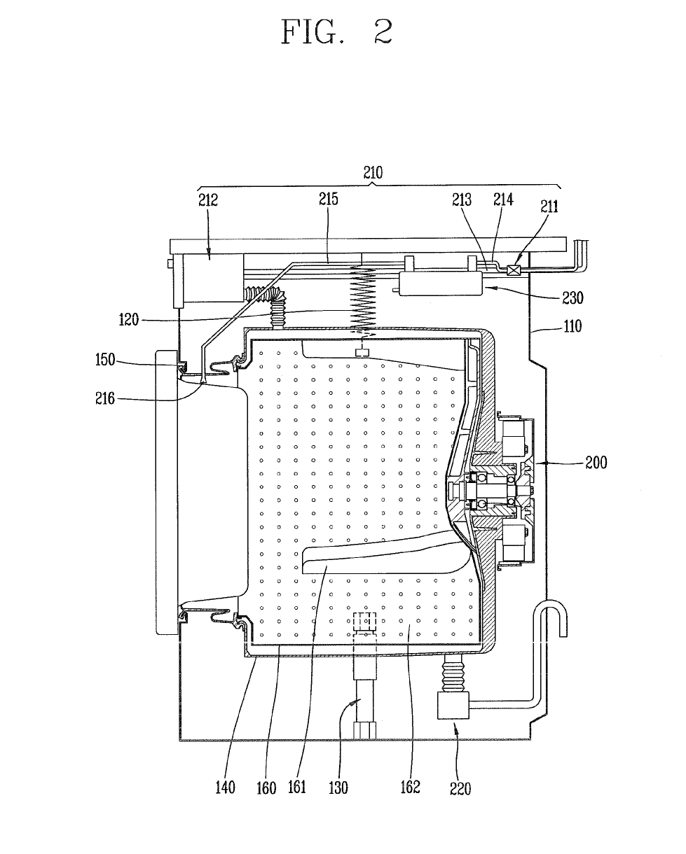

FIG. 1 is a perspective view illustrating a steam jet drum washing machine which is one example of a clothes treating machine to which the present invention is applied. FIG. 2 is a lateral cross-sectional view illustrating the steam jet drum washing machine shown in FIG. 1.

With reference to FIGS. 1 and 2, a drum washing machine 100 according to an exemplary embodiment of the invention includes a cabinet 110 having an opening 181 therein to put and take laundry into and out of the drum washing machine therethrough; a door 170 for opening and closing the opening 181; a tub 140 installed inside the cabinet 110 while absorbing shock is provided, the tub 140 in which water is contained; a water supply unit 104 including water supply paths 213 and 214 to supply water to the tub 140; a drainage device 220 draining contaminated water in the tub 140; a drum 160 rotatably arranged inside the tub 140, the drum 160 in which laundry is placed; a motor 200 installed at the tub 140 to rotate the drum 160; and a door switch 171 for locking or releasing the door 170.

In addition, a gasket 180 is installed around edges of the opening 181 to seal gaps between the opening 181 and the tub 140.

Here, the gasket 180 is substantially in the shape of a ring or a loop that has a predetermined height and is folded so central portions overlap with each other. That is, the gasket 180 that is shaped as if it encompassed upper and lower parts of the door 170 is folded to overlap.

In addition, a control panel 190 is formed on an upper side of a front face of the drum washing machine 100. The control panel 190 has a plurality of controllers, input units, and display units that include a display unit 191 that displays various types of information containing use information of the drum washing machine 100 and an input unit 192 that receives external input made by a user or an administrator.

A control apparatus 300 that controls the drum washing machine 100, including the display unit 191, according to signals input from the plurality of input units or embedded control algorithms is provided in the control panel 190. The control apparatus 300 may be provided at another position of the drum washing machine 100.

More specifically, as shown in FIG. 2, the drum washing machine 100 includes the cabinet 110 that forms the exterior, the tub 140 that is suspended by a spring 120 inside the cabinet 110 and supported by a damper assembly 130, the drum 160 that is rotatably installed inside the tub 140 such that water and laundry are put in the drum 160, a lift 161 that protrudes from an inner wall surface of the drum 160 by a predetermined interval, and lifts and drops laundry as the drum 160 rotates, the motor 200 that is located behind the tub 140, connected to the drum 160, and rotates the drum 160, and a steam generator 230 that is located above the tub 140, heats water to produce high pressure, high temperature steam, and supplies the steam into the tub 140 and the drum 160.

In addition, as shown in FIG. 2, a discharge side of the steam generator 230 may communicate with the inner space of the tub 140.

In addition, the drum washing machine 100 further includes a water supply unit 210 that is located above the tub 140 and supplies water into the tub 140 and the drum 160, and a drainage device 220 that is located below the tub 140 and drains water in the tub 140 and the drum 160. The steam generator 230 is connected to the water supply unit 210.

Specifically, the water supply unit 210 includes a water supply valve assembly 211 that is provided at a rear surface of the cabinet 110 and determines whether or not to supply water, a detergent box assembly 212 that is connected between the water supply valve assembly 211 and the tub 140 and stores detergent therein, first and second water supply paths 213 and 214 that branch off from the water supply valve assembly 211 and are connected to the detergent box assembly 212 and the steam generator 230, respectively, and a steam path 215 that has one end connected to the steam generator 230 and the other end located inside the tub 140 and the drum 160 and supplies steam into the tub 140 and the drum 160.

Here, the drum 160 has a plurality of dehydration holes 162 in the inner wall surface so that water can freely move to the drum 160 and the tub 140 and be separated from laundry by centrifugal force during dehydration. The water supply valve assembly 211 and the drainage device 220 are configured to include a water supply valve (not shown) and a drainage pump (not shown), respectively, and supply water and drain water according to the operations of the water supply valve and the drainage pump, respectively.

Detailed description has been made with an example of a washing and drying drum washing machine. However, a control apparatus and method of a clothes treating machine according to an exemplary embodiment of the invention can be applied to various types of washers and dryers.

The clothes treating machine according to the exemplary embodiment of the invention may include a dryer. For example, as shown in FIG. 10, a ductless dryer is illustrated. The ductless dryer includes a body 1110 that forms the exterior thereof, a drum 1120 that is rotatably installed in the body 1110, the drum 1120 in which an object to be dried is received, and a heat exchanger unit 1150 that removes moist contained in air exhausted from the drum 1120. In addition, a door 1111 is installed at a front surface of the body 1110 so as to input clothes to the drum 1120, and a foot 1113 is installed at a lower side thereof to support the body 1110. A belt 1131 that rotates the drum 1120 and a motor 1135 that supplies a driving force to the belt 1131 are provided inside the body 1110. A pulley by which is the belt 1131 is caught is installed at a shaft of the motor 1135. The drum 1120 is a container that has an inner space to which clothes, which is an object to be dried, is input, and has a plurality of lifters 1121 therein to lift clothes. A hot air supply unit 1140 includes a gas valve 1141 that supplies and cuts gas, a gas combuster 1143 that mixes gas exhausted from the gas valve 1141 with air supplied from the outside and ignites to generate hot air, and a hot air supply duct 1145 that connects the gas combuster 1143 and the drum 1120 to supply the generated hot air to the drum 1120. The heat exchanger unit 1150 is formed of a pin 1151 and a tube 1153 and condenses air of high temperature and humidity from the drum 1120 by low-temperature water through heat exchange between air and water to make air dry. An inlet of the heat exchanger unit 1150 is connected to the drum 1120 by a circulation unit 1180, and an outlet thereof is connected to an exhaust duct 1181. The pin 1151 is formed of a plurality of thin plates formed of metal with excellent conductivity. Here, the plurality of thin plates are laminated with fine intervals therebetween so that air of high temperature and humidity comes into vertical contact with and passes through the thin plates. Water of low temperature (for example, 22° C.) circulates in the tube 1153 and passes through the pin 1151 back and forth. A water hose (not shown) that supplies and retrieves water of low temperature is connected to both sides of the tube 1153. A storage unit that collects condensation water that is generated and dropped during condensation is installed at the lower part of the heat exchanger unit 1150.

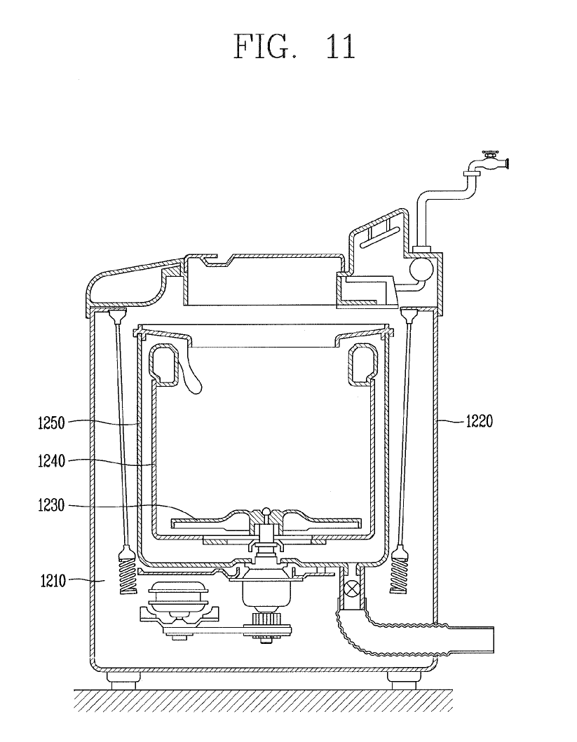

The clothes treating machine according to the exemplary embodiment of the invention includes other types of washing machines in addition to the drum washing machine. For example, as shown in FIG. 11, a top load washing machine is also included.

With reference to FIG. 11, a top load washing machine 1210 includes a casing 1220 that forms the exterior thereof, an outer tub 1250 that is fixed to the inside of the casing 1220, an inner tub 1240 that is rotatably installed in the outer tub 1250, a rotating wing 1230, and a motor that transfers a rotary force to the inner tub 1240. In addition, the top load washing machine 1210 includes a controller that controls a washing process, a water supply device that supplies water required to do the laundry, and a drainage device that drains water.

FIG. 3 is a block diagram illustrating a control apparatus of a clothes treating machine according to an exemplary embodiment of the present invention.

With reference to FIG. 3, a control apparatus of a clothes treating machine according to a first embodiment of the present invention includes a manipulation unit 310 that determines an operation to be performed by the clothes treating machine or re-determines a predetermined operation, a controller 330 that calculates expected power consumption according to the determined or re-determined operation, and a display unit 350 that displays the expected power consumption or corresponding greenhouse gas emissions or displays both the expected power consumption and the greenhouse gas emissions.

The user inputs an operation to be performed in the clothes treating machine 100 by using the manipulation unit 310.

The controller 330 calculates expected power consumption of the clothes treating machine on the basis of the determined operation.

In addition, the controller 330 calculates expected greenhouse gas emissions of an energy source that is supplied to the clothes treating machine on the basis of the calculated expected power consumption. For example, the controller 330 may calculate expected greenhouse gas emissions by multiplying the carbon dioxide index according to the energy source and the calculated expected power consumption. Here, fossil fuels such as oil and gas, alternative energy sources such as solar light, solar heat, wind power, tidal power, hydropower, and geothermal power, nuclear power, and fuel cells may be used as the energy source, and a greenhouse gas index according to each energy source, for example, a carbon dioxide index may be determined through experiments.

Fossil fuels have higher carbon dioxide indexes than other energy sources. Greenhouse gas indexes including the carbon dioxide indexes are determined through the entire procedure from constructing generation systems, generating and supplying energy to disposing of waste. Therefore, in the case of an alternative energy source, a carbon dioxide index should ideally be zero, but fossil fuels are actually used to construct generation systems. Thus, the alternative energy source has a carbon dioxide index having a certain value instead of zero.

The control apparatus 300 may further include a storage unit 360 that stores an electricity price table and a display unit 350 that displays the expected power consumption and determined operation state. The display unit 191 included in the clothes treating machine 100 may be used as the display unit 350.

The storage unit 360 stores a data table generated by obtaining the relationship between power consumption required by the clothes treating machine according to the operation determined in the clothes treating machine and electricity prices corresponding to the power consumption through experiments.

In addition, the storage unit 360 stores the greenhouse gas index according to the kind of the energy source and the corresponding electricity price table. For example, the storage unit 360 may store the carbon dioxide index according to each energy source and electricity price table by expected carbon dioxide emissions calculated according to the power consumption. That is, the storage unit 360 may store a message indicating that when carbon dioxide emissions exceed a predetermined amount, electricity prices may soar and send the message to the user by the controller 330.

The display unit 350 may display expected electricity prices calculated from the expected power consumption, the determined operation state, the expected power consumption, the kind of the energy source, expected carbon dioxide emissions, water supply temperature, and recommended operation conditions. In addition, the display unit 350 may display statistics showing changes over time and the cumulative totals of the expected electricity prices, the expected power consumption, and the expected greenhouse gas emissions.

The controller 330 may compare the determined operation with the recommended operation conditions and inform the user whether to re-determine the determined operation when large discrepancies exist between the determined operation and the recommended operation conditions as a result of the comparison.

In this case, the user can check the corresponding energy rates while changing the setting of the input operation by using the manipulation unit 310, thereby enabling reasonable setting in consideration of electricity prices.

That is, when the user sets an operation of the washing machine such as washing course, boiling temperature, number of rinses, dehydration speed, and dry mode by using the manipulation unit 310, the controller 330 calculates expected power consumption by using the operation and then calculates electricity prices. When the expected power consumption is calculated, values having been obtained through experiments are used to build a database, and the values that are stored in a memory of the controller are read out.

In addition, the user may select one energy source among the energy sources by using the manipulation unit 310. That is, the control apparatus may replace the current fossil fuel as the energy source with another energy source having a relatively lower greenhouse gas index if expected carbon dioxide emissions exceed or are expected to exceed a predetermined amount while the clothes treating machine is being used with the current fossil fuel.

The control apparatus according to the present invention further includes an electric energy detection unit (not shown) that is connected to an input power source and detects electric energy that is supplied to the clothes treating machine. Hereinafter, power that is supplied to the clothes treating machine will be referred to as supplied power to tell apart the expected power consumption. The electric energy detection unit (not shown) detects supplied power that is input to the clothes treating machine. The control apparatus can calculate greenhouse gas emissions of the energy source and electricity prices on the basis of the detected supplied power and provide the user with information about energy saving. In addition, the control apparatus may provide user with statistics showing changes over time and the cumulative totals of the expected electricity prices, the expected power consumption, and the expected greenhouse gas emissions by the display unit.

In addition, the control apparatus according to the present invention further includes a communication unit (not shown) that is connected to an external power supply and exchanges information with the external power supply. The communication unit is connected to the external power supply through wired/wireless communications, particularly, serial communication, the Internet, power line communication, and wireless LAN. In addition, the control apparatus may receive information about the kind of the energy source and the greenhouse gas index according to the energy source from the external power supply through the communication unit. The external power supply may be installed at a power supplier or on site at a house.

When receiving information about power consumed by the individual home appliances, that is, power consumed by the clothes treating machine from the external power supply, the control apparatus may calculate electricity prices or greenhouse gas emissions on the basis of the received information about power consumption.

The communication unit is connected to an external device and transmits data detected, operated, or generated by the controller to the external device. That is, the communication unit sends power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, the weight of laundry received in the drum of the clothes treating machine, the temperature of water supplied to the drum according to the determined operation, and driving information of the clothes treating machine such as and information about energy saving, and messages, and receives various types of information and control commands if necessary. The communication unit is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

The control apparatus may further include a sensing unit 320 that senses at least one of the laundry weight, water supply temperature, operating states of loads, and variations of the loads.

The sensing unit 320 senses laundry weight and water supply temperature and transmits information about the sensed laundry weight and the sensed water supply temperature to the controller 330. The sensing unit 320 senses various types of information required to perform general operations of the washing machine. The sensing unit 320 may further include a sensor for sensing water levels, a sensor for sensing a degree of rinse, a sensor for sensing an unbalanced laundry load, and a sensor for sensing vibrations of the washing machine. In addition, the sensing unit 320 transmits information sensed by the sensors to the controller 330. The sensing unit 320 includes a laundry weight sensing unit 321 and a temperature sensing unit 322. In addition, the sensing unit 320 may include a gas sensing unit (not shown) that senses greenhouse gases such as carbon dioxide that is generated from the clothes treating machine itself. The laundry weight sensing unit 321 senses the amount of laundry received in the drum of the clothes treating machine 100, while the temperature sensing unit 322 senses the temperature of water being supplied to the drum.

With reference to FIG. 3, a control apparatus of a clothes treating machine according to a second embodiment of the present invention includes a sensing unit 320 that senses at least one piece of information including the laundry weight, water supply temperature, operating states of loads, and variations of the loads, a controller 330 that calculates expected power consumption according to the sensed information, and a display unit 350 that displays expected power consumption or corresponding greenhouse gas emissions or displays both the expected power consumption and the greenhouse gas emissions.

The control apparatus of the clothes treating machine according to the present invention may include a manipulation unit 310 that determines an operation to be performed by the clothes treating machine or re-determines the determined operation.

The sensing unit 320 senses laundry weight and water supply temperature and transmits information about the sensed laundry weight and the water supply temperature to the controller 330. The controller 330 calculates expected power consumption of the clothes treating machine on the basis of at least one of the sensed laundry weight and the sensed water supply temperature.

In addition, the controller 330 calculates expected carbon dioxide emissions of an energy source being supplied to the clothes treating machine on the basis of the calculated expected power consumption. For example, the controller 330 may calculate expected greenhouse gas emissions by multiplying a carbon dioxide index according to the energy source and the calculated expected power consumption. Here, fossil fuels such as oil and gas, alternative energy sources such as solar light, solar heat, wind power, tidal power, hydropower, and geothermal power, nuclear power, and fuel cells may be used as the energy source, and a greenhouse gas index according to each energy source, for example, a carbon dioxide index may be determined through experiments.

Fossil fuels have higher carbon dioxide indexes than other energy sources. Greenhouse gas indexes including the carbon dioxide indexes are determined through the entire procedure from constructing generation systems, generating and supplying energy to disposing of waste. Therefore, in the case of an alternative energy source, a carbon dioxide index should ideally be zero, but fossil fuels are actually used to construct generation systems. Thus, the alternative energy source has a carbon dioxide index having a certain value instead of zero.

The sensing unit 320 senses various types of information required to perform general operations of the washing machine. The sensing unit 320 may further include a sensor for sensing water levels, a sensor for sensing a degree of rinse, a sensor for sensing an unbalanced laundry load, and a sensor for sensing vibrations of the washing machine. In addition, the sensing unit 320 transmits information sensed by the sensors to the controller 330.

A load 340 receives a signal from the controller 330 and supplies a driving force to perform an operation. The load 340 includes a motor 200 that rotates the washing drum, a heater (not shown) that heats supplied water to boil laundry, a heater (not shown) that supplies steam, a heater (not shown) that heats air to dry laundry, a fan motor (not shown) that generates airflow during drying.

The control apparatus 300 may include a storage unit 360 that stores an electricity price table and a display unit 350 that displays the expected electricity prices and the determined operation state. As the display unit 350, the display unit 191 included in the clothes treating machine 100 may be used.

The storage unit 360 stores a data table generated by obtaining the relationship between power consumption required by the clothes treating machine according to the weight of laundry received in the drum of the clothes treating machine and the temperature of water supplied into the drum, and electricity prices corresponding to the power consumption through experiments.

In addition, the storage unit 360 stores the greenhouse gas index according to the kind of the energy source and the corresponding electricity price table. For example, the storage unit 360 may store the carbon dioxide index according to each energy source and electricity price table by expected carbon dioxide emissions calculated according to the power consumption. That is, the storage unit 360 may store a message indicating that when carbon dioxide emissions exceed a predetermined amount, electricity prices may soar and send the message to the user by the controller 330.

The display unit 350 may display expected electricity prices calculated from the expected power consumption, expected power consumption, kinds of energy sources, expected carbon dioxide emissions, water supply temperature, and recommended operation conditions. In addition, the display unit 350 may display statistics showing changes over time and the cumulative totals of the expected electricity prices, the expected power consumption, and the expected greenhouse gas emissions.

The sensing unit 320 includes a laundry weight sensing unit 321 and a temperature sensing unit 322. In addition, the sensing unit 320 may include a gas sensing unit (not shown) that senses greenhouse gases such as carbon dioxide that is generated from the clothes treating machine itself.

The laundry weight sensing unit 321 senses the weight of laundry received in the drum of the clothes treating machine 100, while the temperature sensing unit 322 senses the temperature of water being supplied to the drum. The controller 330 calculates the expected power consumption and the electricity prices according to the laundry weight and the water supply temperature transmitted from the sensing unit 320. When the expected power consumption is calculated, values having been obtained through experiments are used to build a database, and the values that are stored in a memory of the controller are read out.

In addition, the user may select one energy source among the energy sources by using the manipulation unit 310. That is, the control apparatus may replace the current fossil fuel as the energy source with another energy source having a relatively lower greenhouse gas index if expected carbon dioxide emissions exceed or are expected to exceed a predetermined amount while the clothes treating machine is being used with the current fossil fuel.

The control apparatus according to the present invention further includes an electric energy detection unit (not shown) that is connected to an input power source and detects electric energy that is supplied to the clothes treating machine. Unlike a watt hour meter that is provided in houses according to the related art to detect the total electric energy, the electric energy detection unit is individually connected to the clothes treating machine and detects necessary power consumption of the clothes treating machine according to the weight of laundry received in the drum of the clothes treating machine and the temperature of water supplied into the drum or change commands from the user. The control apparatus may calculate greenhouse gas emissions of the energy source and electricity prices on the basis of the detected supplied power and provide information about energy saving to the user. In addition, the control apparatus may provide the user with statistics showing changes over time and the cumulative totals of the expected electricity prices, the expected power consumption, and the expected greenhouse gas emissions by the display unit.

In addition, the control apparatus according to the present invention further includes a communication unit (not shown) that is connected to the external power supply and exchanges information with the external power supply. The communication unit is connected to the external power supply through wired/wireless communications, particularly, serial communication, the Internet, power line communication, and wireless LAN. In addition, the control apparatus may receive information about the kind of the energy source and the greenhouse gas index according to the energy source from the external power supply through the communication unit. The external power supply may be installed at a power supplier or on site at a house.

When receiving information power consumed by the individual home appliances, that is, power consumed by the clothes treating machine from the external power supply, the control apparatus can calculate electricity prices or greenhouse gas emissions on the basis of the received information about power consumption.

The communication unit is connected to an external device and transmits data detected, operated, or generated by the controller to the external device. That is, the communication unit sends power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, the weight of laundry received in the drum of the clothes treating machine, the temperature of water supplied to the drum according to the determined operation, and driving information of the clothes treating machine such as and information about energy saving, and messages, and receives various types of information and control commands if necessary. The communication unit is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

With reference to FIG. 3, a control apparatus of a clothes treating machine according to a third embodiment of the present invention includes an electric energy detection unit (not shown) that is connected to an input power source and detects electric energy that is supplied to the clothes treating machine, a controller 330 that calculates greenhouse gas emissions or electricity prices according to the supplied power, and a display unit 350 that displays at least one of the supplied power, the greenhouse gas emissions, and the electricity prices.

The controller 330 creates at least one message that includes energy-saving tips according to the operation of the clothes treating machine or recommended operation conditions on the basis of at least one piece of information including the supplied power, the electricity prices, and the greenhouse gas emissions, and the display unit 350 further displays the message.

The control apparatus of the clothes treating machine according to the present invention further includes a storage unit 360 that stores the supplied power, the electricity prices, the greenhouse gas emissions, and the message.

The electric energy detection unit detects the supplied power that is input to the clothes treating machine. The electric energy detection unit can detect electric energy according to various methods. For example, the electric energy detection unit may detect current and voltage that are applied to the clothes treating machine by a current detection unit (not shown) and a voltage detection unit (not shown) and reflect time measured by a timer to detect electric energy. Unlike a watt hour meter that is provided in houses according to the related art to detect the total electric energy, the electric energy detection unit is individually connected to the clothes treating machine and detects necessary power consumption of the clothes treating machine according to a determined operation, the weight of laundry received in the drum of the clothes treating machine, and the temperature of water supplied into the drum according to the determined operation, or change commands from the user. The control apparatus may calculate greenhouse gas emissions of the energy source and electricity prices on the basis of the detected supplied power and provide the user with information about energy saving. In addition, the control apparatus may provide the user with statistics showing changes over time and the cumulative totals of the electricity prices, the power consumption, and the expected greenhouse gas emissions by the display unit.

The control apparatus of the clothes treating machine according to the present invention further includes a communication unit (not shown) that receives a kind of an energy source generating input power and a greenhouse gas index according to the energy source and transmits the message.

The communication unit is connected to the external power supply through wired/wireless communications, particularly, serial communication, the Internet, power line communication, and wireless LAN. In addition, the control apparatus may receive information about the kind of the energy source and the greenhouse gas index according to the energy source from the external power supply through the communication unit. The external power supply may be installed at a power supplier or on site at a house.

When receiving information about power consumed by the individual home appliances, that is, power consumed by the clothes treating machine from the external power supply, the control apparatus may calculate electricity prices or greenhouse gas emissions on the basis of the received information about power consumption.

The communication unit is connected to an external device and transmits data detected, operated, or generated by the controller to the external device. That is, the communication unit sends power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, the weight of laundry received in the drum of the clothes treating machine, the temperature of water supplied to the drum according to the determined operation, and driving information of the clothes treating machine such as and information about energy saving, and messages, and receives various types of information and control commands if necessary. The communication unit is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

The control apparatus of the clothes treating machine according to the present invention may further include a sensing unit 320 that senses at least one piece of information including laundry weight, water supply temperature, operating states of loads, and variations of the loads.

The control apparatus of the clothes treating machine according to the present invention may further include a manipulation unit 310 that determines an operation to be performed by the clothes treating machine or re-determines the determined operation.

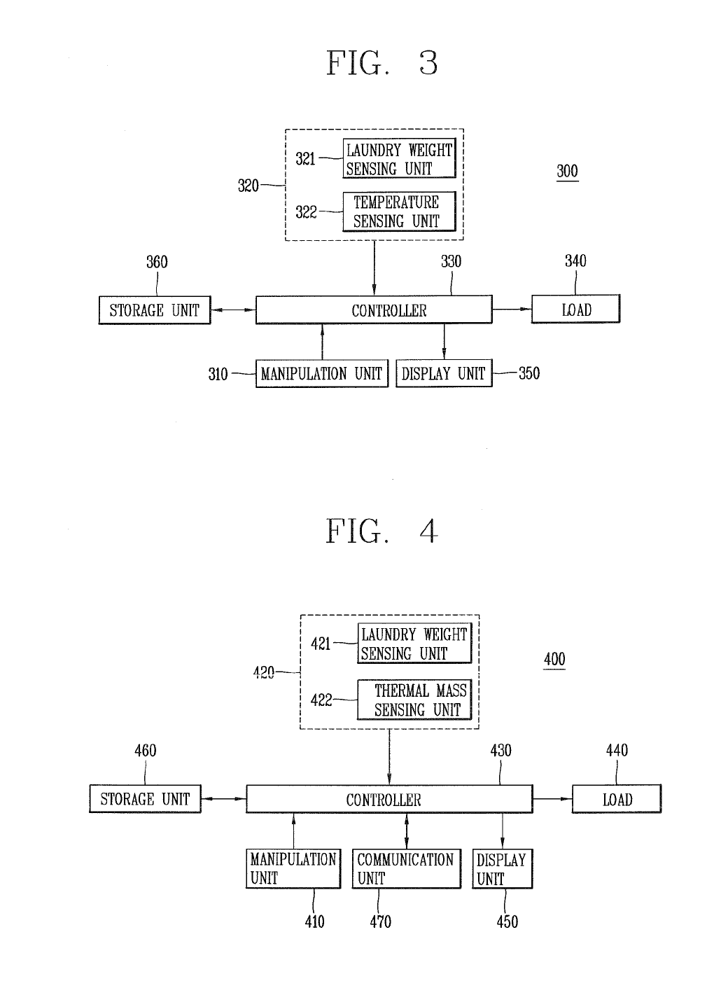

FIG. 4 is a block diagram illustrating a control apparatus of a clothes treating machine according to another exemplary embodiment of the present invention.

As shown in FIG. 4, a control apparatus 400 of the clothes treating machine according to another exemplary embodiment of the present invention includes a sensing unit 420 that senses at least one piece of information including laundry weight, water supply temperature, operating state of load, and variations of load, a manipulation unit 410 that determines an operation to be performed by the clothes treating machine or re-determines the determined operation, and a display unit 450 that displays expected power consumption according to the determined operation or the sensed information. In addition, the control apparatus 400 of the clothes treating machine according to another exemplary embodiment of the present invention includes a controller 430 that estimates expected power consumption according to the determined operation or the sensed information.

The manipulation unit 410 receives settings of the washing machine such as washing course, boiling temperature, number of rinses, dehydration speed, and dry mode from the user.

The sensing unit 420 includes a speed sensing unit 421 that senses speed variation of the motor and a thermal mass sensing unit 422 that senses thermal mass generated from a calorie generation unit of the clothes treating machine.

When the motor of the drum washing machine 100 is not a motor with rated output but a variable speed motor capable of varying speed, the speed sensing unit 421 senses the speed of the motor because power consumption changes according to the speed. When water being supplied is heated to increase the temperature of the water, the thermal mass sensing unit 422 also measures the temperature of water being supplied because power consumed to heat supplied water to the final target temperature changes according to the temperature of water being supplied.

That is, the sensing unit 420 senses the On/Off state of the load operating according to the operation determined in the clothes treating machine or a state of a load other than rated load.

The controller 430 estimates power consumption of the clothes treating machine on the basis of the sensed operating state of the load. A storage unit 460 stores correction values of at least the estimated power consumption and the power consumption calculated according to the laundry weight and the load variations. The display unit 450 displays at least expected electricity prices calculated from the estimated power consumption, expected carbon dioxide emissions according to the energy source, and determined operation state. In addition, the display unit 450 may display changes over time and the cumulative totals of the expected electricity prices, the expected power consumption, and the expected carbon dioxide emissions.

In addition, when the load is a variable load, the controller 430 corrects the estimated power consumption on the basis of variations of the load and the laundry weight. The variable load includes at least a heater and a variable speed motor that do not consume a fixed amount of power but consume different amounts of power according to load amount.

In particular, when the load is operating, the controller 430 estimates power consumption by adding rated power of all operating loads, accumulates the estimated power consumption or corrected power consumption for a predetermined amount of time to obtain cumulative power consumption, and calculates expected carbon dioxide emissions or expected electricity prices from the cumulative power consumption.

That is, the controller 430 receives various types of information from the sensing unit 420, controls and operates various kinds of loads required to perform operations of the washing machine, instructs the state of each load to perform washing operations, calculates instantaneous power and then accumulates the calculated instantaneous power to obtain the final power consumption, and calculates expected carbon dioxide emissions according to the energy source or expected electricity prices.

The control apparatus according to the present invention further includes an electric energy detection unit (not shown) that is connected to an input power source and detects electric energy that is supplied to the clothes treating machine. Hereinafter, power that is supplied to the clothes treating machine will be referred to as supplied power to tell apart the expected power consumption. The electric energy detection unit (not shown) detects supplied power that is input to the clothes treating machine. The electric energy detection unit (not shown) may detect electric energy by various methods. For example, the electric energy detection unit may detect current and voltage that are applied to the clothes treating machine by a current detection unit (not shown) and a voltage detection unit (not shown) and reflect time measured by a timer to detect electric energy. Unlike a watt hour meter that is provided in houses according to the related art to detect the total electric energy, the electric energy detection unit is individually connected to the clothes treating machine and detects necessary power consumption of the clothes treating machine according to a determined operation, the weight of laundry received in the drum of the clothes treating machine, and the temperature of water supplied into the drum according to the determined operation, or change commands from the user. The control apparatus may calculate greenhouse gas emissions of the energy source and electricity prices on the basis of the detected supplied power and provide the user with information about energy saving. In addition, the control apparatus may provide the user with statistics showing changes over time and the cumulative totals of the electricity prices, the power consumption, and the expected greenhouse gas emissions by the display unit.

In addition, the control apparatus according to the present invention further includes a communication unit 470 that is connected to an external power supply and exchanges information with the external power supply. The communication unit 470 is connected to the external power supply through wired/wireless communications, particularly, serial communication, the Internet, power line communication, and wireless LAN. In addition, the control apparatus may receive information about the kind of the energy source and the greenhouse gas index according to the energy source from the external power supply through the communication unit 470. The external power supply may be installed at a power supplier or on site at a house.

When receiving information about power consumed by the individual home appliances, that is, power consumed by the clothes treating machine from the external power supply, the control apparatus may calculate electricity prices or greenhouse gas emissions on the basis of the received information about power consumption.

The communication unit is connected to an external device and transmits data detected, operated, or generated by the controller to the external device. That is, the communication unit sends power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, the weight of laundry received in the drum of the clothes treating machine, the temperature of water supplied to the drum according to the determined operation, and driving information of the clothes treating machine such as and information about energy saving, and messages, and receives various types of information and control commands if necessary. The communication unit is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

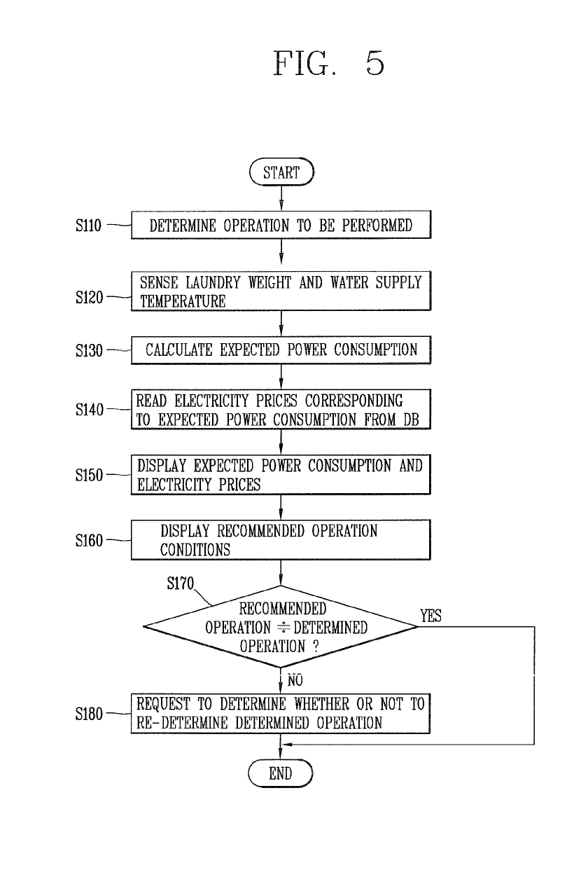

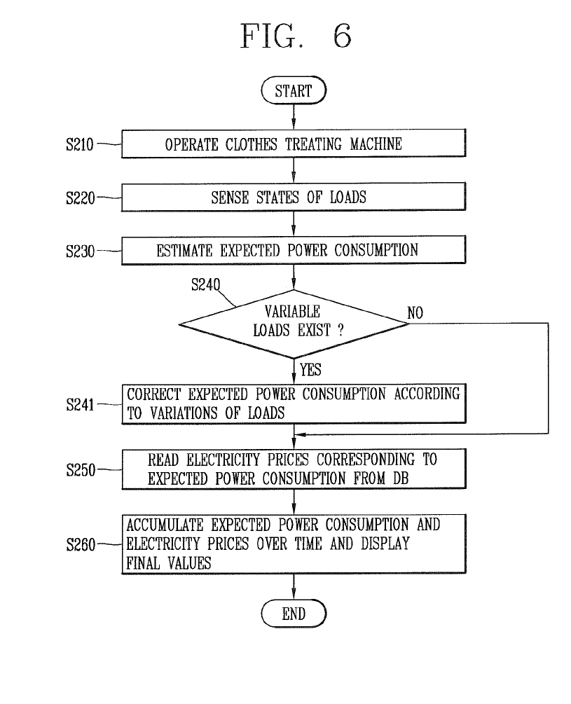

With reference to FIG. 5 or 6, according to a method of controlling the clothes treating machine according to the exemplary embodiments of the present invention, expected power consumption is calculated on the basis of at least one piece of the sensed information including an operation to be performed by the clothes treating machine or laundry weight, water supply temperature, operating states of loads, and variations of the loads, or supplied power that is input to the clothes treating machine is detected, and the expected power consumption or the supplied power is displayed, and electricity prices or greenhouse gas emissions are calculated on the basis of the expected power consumption or the supplied power, and the electricity prices or the greenhouse gas emissions are further displayed.

According to the method of controlling the clothes treating machine according to the present invention, at least one message that contains energy-saving tips according to the operation of the clothes treating machine or recommended operation conditions on the basis of at least one of the expected power consumption or the supplied power, the electricity prices, the greenhouse gas emissions, the operation, and the sensed information is created, and the message is further displayed.

FIG. 5 is a flowchart illustrating a control method of a clothes treating machine according to an exemplary embodiment of the present invention.

With reference to FIG. 5, a control method of a clothes treating machine according to a first embodiment includes receiving an operation to be performed by the clothes treating machine in operation S110 and displaying expected power consumption according to the determined operation in operation S150. The control method of the clothes treating machine according to this embodiment further includes calculating expected power consumption according to the predetermined operation in operation S130. In addition, according to the control method, electricity prices are calculated on the basis of the expected power consumption in operation S140. The control method of the clothes treating machine according to the first embodiment may further include sensing at least one piece of information including laundry weight, water supply temperature, operating states of loads, and variations of the loads in operation S120.

With reference to FIG. 5, a control method of a clothes treating machine according to a second embodiment includes sensing at least one piece of information including laundry weight, water supply temperature, operating states of loads, and variations of the loads in operation S120 and displaying expected power consumption according to the sensed information in operation S150. The control method of the clothes treating machine according to the second embodiment further includes calculating expected power consumption according to the sensed information in operation S130. Also, according to the control method, electricity prices are calculated on the basis of the expected power consumption in operation S140. The control method of the clothes treating machine according to the second embodiment may further include an operation to be performed by the clothes treating machine in operation S110.

During the calculating of the electricity prices in operation S140, rates with respect to the estimated power consumption are read out from a database that stores rates according to power consumption obtained through experiments.

Also, the control method may further include calculating expected carbon dioxide emissions according to an energy source on the basis of the expected power consumption (not shown). At this time, the expected carbon dioxide emissions may be calculated by multiplying the expected power consumption and the greenhouse gas index. Here, fossil fuels such as oil and gas, alternative energy sources such as solar light, solar heat, wind power, tidal power, hydropower, and geothermal power, nuclear power, and fuel cells may be used as the energy source, and according to each energy source, for example, a carbon dioxide index may be determined through experiments.

In addition, the control method may further include storing the greenhouse gas index and the corresponding electricity price table in advance (not shown). That is, the carbon dioxide index according to each energy source may be stored, and an electricity price table by expected carbon dioxide emissions calculated according to the power consumption may be stored. That when carbon dioxide emissions exceed a predetermined amount, electricity prices may soar may be stored and be provided to the user. In addition, the user may be informed to replace the current fossil fuel as the energy source with another energy source having a relatively lower greenhouse gas index if expected carbon dioxide emissions exceed or are expected to exceed a predetermined amount while the clothes treating machine is being used with the current fossil fuel.

In addition, the control method further includes detecting power supplied to the clothes treating machine (not shown). In the process of detecting the supplied power, electric power may be detected by various methods. For example, current and voltage that are applied to the clothes treating machine may be detected, and time measured by a timer may be reflected to detect power consumption. In the control method, a watt hour meter that is provided in houses according to the related art to detect the total electric energy is not used. The control method may include being individually connected to the clothes treating machine, and detecting necessary power consumption of the clothes treating machine according to states such as the weight of laundry received in the drum of the clothes treating machine and the temperature of water supplied into the drum or the determined operation from the user. Greenhouse gas emissions of the energy source and electricity prices may be calculated on the basis of the detected supplied power, and information about energy saving may be provided to the user. In addition, the user may be provided with statistics showing changes over time and the cumulative totals of the electricity prices, the power consumption, and the expected greenhouse gas emissions.

In addition, the control method may include being connected to an external power supply through wired/wireless communications, particularly, serial communication, the Internet, power line communication, and wireless LAN and receiving information about the kind of the energy source and the greenhouse gas index according to the energy source from the external power supply (not shown).

In addition, the control method may further include receiving information about power consumed by the individual home appliances, that is, power consumed by the clothes treating machine from the external power supply (not shown). Electricity prices or greenhouse gas emissions may be calculated on the basis of the received information about power consumption.

Moreover, the control method may further include transmitting data detected, operated, or generated to an external device (not shown). That is, according to the control method, power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, sensed information including the weight of laundry received in the drum of the clothes treating machine and the temperature of water supplied into the drum, a state of the clothes treating machine such as information about energy saving, driving information, and messages are sent to the external device, and various types of information and control commands are received from the external device if necessary. It is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

The control method may include displaying recommended operation conditions on the basis of the input operation, the sensed laundry weight, and the sensed water supply temperature in operation S160, determining whether the discrepancy between the determined operation and the recommended operation exceeds a predetermined range in operation S170, and displaying notification to request the user to determine whether or not to re-determine the determined operation when it exceeds the predetermined range in operation S180.

Information displayed on the display unit 350 as the recommended operation conditions is a rotating speed of the drum of the clothes treating machine during dehydration or drying.

A control method of a clothes treating machine according to a third embodiment of the present invention includes detecting power supplied to the clothes treating machine and calculating greenhouse gas emissions or electricity prices on the basis of the supplied power. In the process of detecting the supplied power, electric energy may be detected by various methods. For example, current and voltage that are applied to the clothes treating machine may be detected, and time measured by a timer may be reflected to detect power consumption. In this process, a watt hour meter that is provided in houses according to the related art to detect the total electric energy is not used. The control method may include being individually connected to the clothes treating machine, and detecting necessary power consumption of the clothes treating machine according to states such as the weight of laundry received in the drum of the clothes treating machine and the temperature of water supplied into the drum or the determined operation from the user. Greenhouse gas emissions of the energy source and electricity prices may be calculated on the basis of the detected supplied power, and information about energy saving may be provided to the user. In addition, the user may be provided with statistics showing changes over time and the cumulative totals of the electricity prices, the power consumption, and the expected greenhouse gas emissions.

In addition, the control method may include being connected to an external power supply through wired/wireless communications, particularly, serial communication, the Internet, power line communication, and wireless LAN and receiving information about the kind of the energy source and the greenhouse gas index according to the energy source from the external power supply (not shown).

In addition, the control method may further include receiving information about power consumed by the individual home appliances, that is, power consumed by the clothes treating machine from the external power supply (not shown). Electricity prices or greenhouse gas emissions may be calculated on the basis of the received information about power consumption.

Moreover, the control method may further include transmitting data detected, operated, or generated to an external device (not shown). That is, according to the control method, power consumption of detected supplied power, electricity prices according to the power consumption, expected carbon dioxide emissions of the energy source according to the power consumption, statistics showing changes over time and the cumulative totals of the power consumption, the electricity prices, and the expected carbon dioxide emissions, a state of the clothes treating machine such as information about energy saving, driving information, and messages are sent to the external device, and various types of information and control commands are received from the external device if necessary. It is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

The control method may include displaying recommended operation conditions on the basis of the input operation, the sensed laundry weight, and the sensed water supply temperature in operation S160, determining whether the discrepancy between the determined operation and the recommended operation exceeds a predetermined range in operation S170, and displaying notification to request the user to determine whether or not to re-determine the determined operation when it exceeds the predetermined range in operation S180. Information displayed on the display unit 350 as the recommended operation conditions is a rotating speed of the drum of the clothes treating machine during dehydration or drying.

FIG. 6 is a flowchart illustrating a control method of a clothes treating machine according to another exemplary embodiment of the present invention.

As shown in FIG. 6, the control method of the clothes treating machine according to another exemplary embodiment of the present invention includes a first process in which the clothes treating machine operates according to a determined operation in operation S210, a process in which respective states of loads related to the determined operation are sensed in operation S220, and a second process in which expected power consumption is estimated on the basis of the sensed states of the loads in operation S230.

The control method may further include calculating electricity prices on the basis of the expected power consumption and displaying the expected power consumption and the electricity prices in operation S260.

In the second process in operation S230, it is determined whether the sensed loads are variable loads or not in operation S240, and the expected power consumption can be corrected according to load amount of the variable loads when the sensed loads are variable loads in operation S241.

Here, the controller 430 accumulates expected power consumption of the loads driven according to time to calculate the expected power consumption and calculates electricity prices on the basis of the accumulated expected power consumption in operation S250.

The electricity prices are calculated by reading rates with respect to the estimated power consumption from a database that stores the rates with respect to power consumption that are obtained through experiments.

In addition, the control method may further include calculating expected carbon dioxide emissions according to the energy source on the basis of the expected power consumption (not shown). At this time, the expected carbon dioxide emissions may be calculated by multiplying the expected power consumption and the greenhouse gas index.

In addition, the control method may further include storing the greenhouse gas index and the corresponding electricity price table (not shown). That is, the carbon dioxide index according to the energy source may be stored, and the electricity price table by expected carbon dioxide emissions calculated according to the power consumption may be stored.

Moreover, the control method further includes detecting power supplied to the clothes treating machine (not shown). In the detection of the supplied power, electric energy may be detected by various methods. For example, a control method of a clothes treating machine according to a third embodiment of the present invention includes detecting power supplied to the clothes treating machine and calculating greenhouse gas emissions or electricity prices on the basis of the supplied power. During the detection of the supplied power, electric energy may be detected by various methods. For example, current and voltage that are applied to the clothes treating machine may be detected, and time measured by a timer may be reflected to detect power consumption. In the control method, a watt hour meter that is provided in houses according to the related art to detect the total electric energy is not used. The control method may include being individually connected to the clothes treating machine, and detecting necessary power consumption of the clothes treating machine according to states such as the weight of laundry received in the drum of the clothes treating machine and the temperature of water supplied into the drum or the determined operation from the user. Greenhouse gas emissions of the energy source and electricity prices may be calculated on the basis of the detected supplied power, and information about energy saving may be provided to the user. In addition, the user may be provided with statistics showing changes over time and the cumulative totals of the electricity prices, the power consumption, and the expected greenhouse gas emissions.

In addition, the control method may include being connected to an external power supply through wired/wireless communications, particularly, serial communication, the Internet, power line communication, and wireless LAN and receiving information about the kind of the energy source and the greenhouse gas index according to the energy source from the external power supply (not shown).

In addition, the control method may further include receiving information about power consumed by the individual home appliances, that is, power consumed by the clothes treating machine from the external power supply (not shown). Electricity prices or greenhouse gas emissions may be calculated on the basis of the received information about power consumption.

Moreover, the control method may further include transmitting data detected, operated, or generated to an external device (not shown). That is, according to the control method, power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, sensed information including the weight of laundry received in the drum of the clothes treating machine and the temperature of water supplied into the drum, a state of the clothes treating machine such as information about energy saving, driving information, and messages are sent to the external device, and various types of information and control commands are received from the external device if necessary. It is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

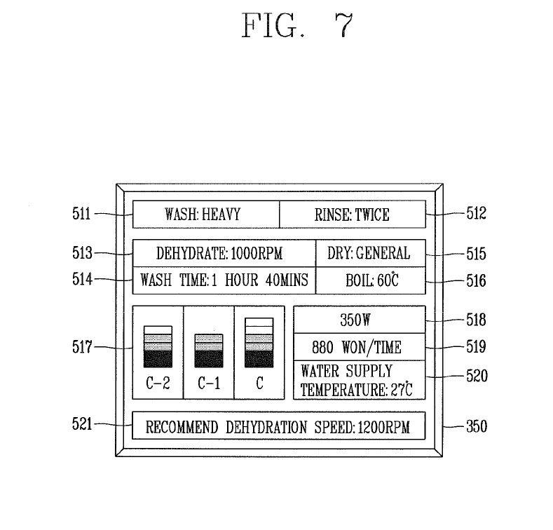

FIG. 7 is a diagram illustrating determined operations, recommended operation conditions, and electricity prices according to expected power consumption and power consumption shown on a display unit of a control apparatus according to an exemplary embodiment of the present invention.

The display unit 350 displays settings when the user sets the washing machine and the progress of the operation of the washing machine when the operation of the washing machine is performed. Operations 511 to 516 determined by the user, expected power consumption 518 and electricity prices 519 according to the determined operations, recommended dehydration speed 521, and relative degrees 517 of power consumed in the previous washing, and the current power consumption are displayed. Here, the display unit 350 may display supplied power detected by the electric energy detection unit instead of the expected power consumption 518, and electricity prices 519 calculated on the basis of the detected supplied power. The display unit 350 may display statistics showing changes according to time and the cumulative totals of the expected power consumption or detected supplied power and electricity prices if necessary.

More specifically, the operations determined by the user include heavy wash 511, two times of rinse 512, dehydration speed of 1000 RPM 513, general drying 515, wash time of 1 hour and 40 minutes, and a boiling temperature of 60° C. In addition, power consumption of the washing machine in relation to the determined operations is 350 W, and electricity prices with respect to the expected power consumption re 880 won. The water supply temperature sensed by the temperature sensing unit 322 is 27° C.

In addition, a recommended dehydration speed of 1200 RPM on the basis of the determined operations, the sensed water supply temperature and the sensed laundry weight is shown on the display unit 350. In addition, power consumption of the washing operation in the previous process in addition to the current process is displayed on the display unit 350, so that the user can recognize power consumption according to the currently set operation conditions.

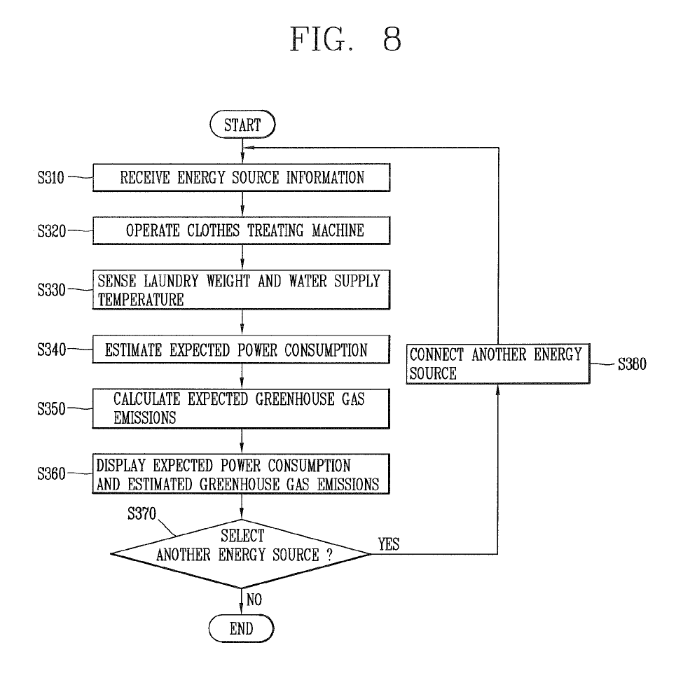

FIG. 8 is a flowchart illustrating a control method of a clothes treating machine according to another exemplary embodiment of the present invention.

As shown in FIG. 8, the control method of the clothes treating machine according to another exemplary embodiment of the present invention includes operating the clothes treating machine in operation S320, sensing laundry weight and water supply temperature in operation S330, estimating expected power consumption on the basis of the sensed laundry weight and the sensed water supply temperature in operation S340, and calculating expected carbon dioxide emissions of the energy source on the basis of the estimated expected power consumption in operation S350. In addition, the control method further includes displaying the estimated expected power consumption and the calculated expected carbon dioxide emissions of the energy source in operation S360.

The expected carbon dioxide emissions may be calculated by multiplying the expected power consumption and the greenhouse gas index. Here, fossil fuels such as oil and gas, alternative energy sources such as solar light, solar heat, wind power, tidal power, hydropower, and geothermal power, nuclear power, and fuel cells may be used as the energy source. A greenhouse gas index according to each energy source, for example, a carbon dioxide index may be determined through experiments.

Also, the control method may further include storing the greenhouse gas index and the corresponding electricity price table in advance (not shown). That is, the carbon dioxide index according to each energy source may be stored, and an electricity price table by expected carbon dioxide emissions calculated according to the power consumption may be stored. That when carbon dioxide emissions exceed a predetermined amount, electricity prices may soar may be stored and be provided to the user.

In addition, the control method further includes detecting power supplied to the clothes treating machine (not shown). In the process of detecting the supplied power, electric power may be detected by various methods. For example, current and voltage that are applied to the clothes treating machine may be detected, and time measured by a timer may be reflected to detect power consumption. In the control method, a watt hour meter that is provided in houses according to the related art to detect the total electric energy is not used. The control method may include being individually connected to the clothes treating machine, and detecting necessary power consumption of the clothes treating machine according to states such as the weight of laundry received in the drum of the clothes treating machine and the temperature of water supplied into the drum or the determined operation from the user. Greenhouse gas emissions of the energy source and electricity prices may be calculated on the basis of the detected supplied power, and information about energy saving may be provided to the user. In addition, the user may be provided with statistics showing changes over time and the cumulative totals of the electricity prices, the power consumption, and the expected greenhouse gas emissions.

The control method further includes receiving information about the energy source applied to the clothes treating machine from the external power supply before the clothes treating machine operates in operation S310. The information about the energy source includes the kind of the energy source and greenhouse gas indexes including the carbon dioxide index according to the energy source. That is, the control method may include being connected to an external power supply through wired/wireless communications, particularly, serial communication, the Internet, power line communication, and wireless LAN and receiving information about the kind of the energy source and the greenhouse gas indexes according to the energy source from the external power supply.

In addition, the control method may further include receiving information about power consumed by the individual home appliances, that is, power consumed by the clothes treating machine from the external power supply (not shown). Electricity prices or greenhouse gas emissions may be calculated on the basis of the received information about power consumption.

Moreover, the control method may further include transmitting data detected, operated, or generated to an external device (not shown). That is, according to the control method, power consumption of expected power consumption calculated or supplied power detected by the clothes treating machine, electricity prices according to the power consumption, expected carbon dioxide emissions of the energy source according to the power consumption, statistics showing changes over time and the cumulative totals of the power consumption, the electricity prices, and the expected carbon dioxide emissions, the determined operation, sensed information including the weight of laundry received in the drum of the clothes treating machine and the temperature of water supplied into the drum, a state of the clothes treating machine such as information about energy saving, driving information, and messages are sent to the external device, and various types of information and control commands are received from the external device if necessary. It is connected to the external device through serial communication, the Internet, power line communication, and wireless LAN. As the external device, wired/wireless communications devices such as cellular phones and PDA phones, monitoring devices such as monitors and televisions, remote controllers, or servers may be used.

In addition, according to the control method, it is determined whether the user selects another energy source when the calculated expected carbon dioxide emissions of the energy source exceed a predetermined amount in operation S370, and it is connected to the selected energy source in operation S380 to thereby receive power. For example, the user may be informed to replace the current fossil fuel as the energy source with another energy source having a relatively lower greenhouse gas index if expected carbon dioxide emissions exceed or are expected to exceed a predetermined amount while the clothes treating machine is being used with the current fossil fuel.

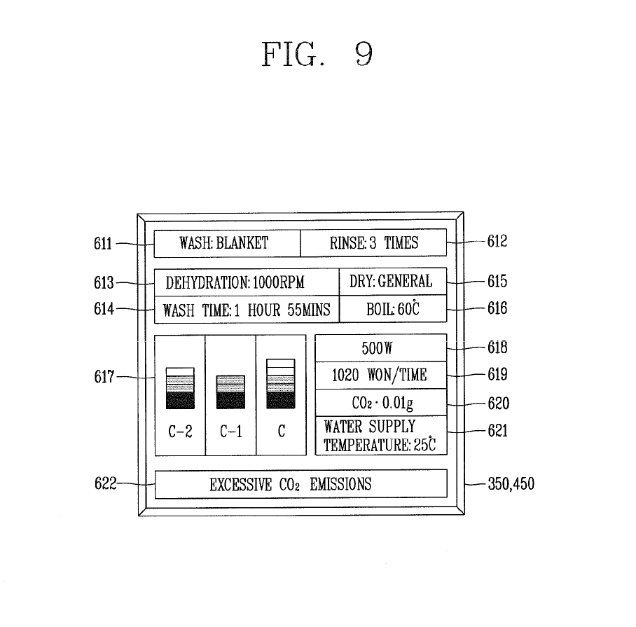

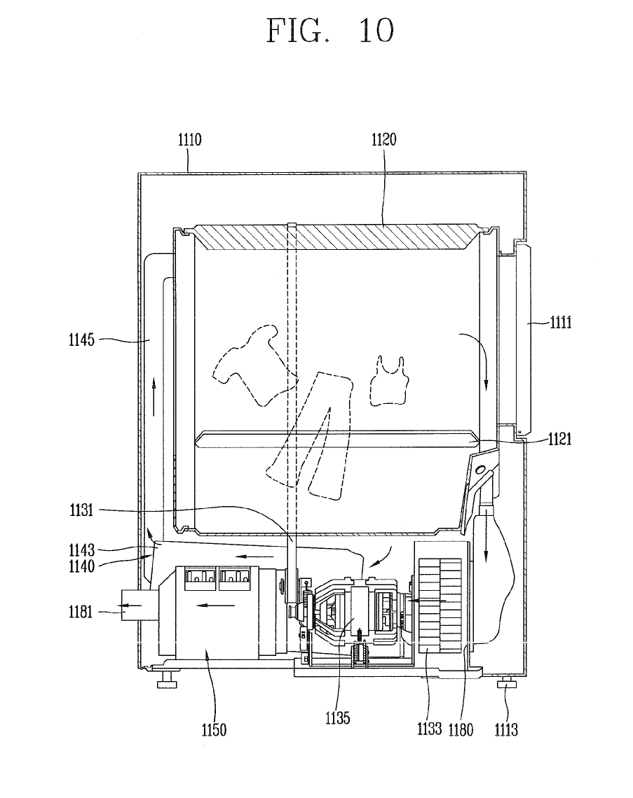

FIG. 9 is a diagram illustrating determined operations, recommended operation conditions, expected carbon dioxide emissions, and electricity prices according to expected power consumption and power consumption shown on a display unit of a control apparatus according to another exemplary embodiment of the present invention.

As shown in FIG. 9, settings when the user sets the clothes treating machine and the progress of operations of the clothes treating machine when the operations of the clothes treating machine are being performed are displayed on the display unit 450. Operations 611 to 616 set by the user, expected power consumption 618 and electricity prices 619 of the washing machine according to the set operations, expected carbon dioxide emissions 620 of the energy source, information about energy saving 622, and the relative degrees 617 of the power consumed by washing in the previous process and the current power consumption are displayed. Here, the display unit 450 may display supplied power detected by the electric energy detection unit instead of the expected power consumption 618, and the electricity prices 619 calculated on the basis of the detected supplied power. The display unit 450 may display statistics showing changes over time and the cumulative totals of the expected power consumption or the detected supplied power, electricity prices, and greenhouse gas emissions if necessary.

1. A control apparatus of a clothes treating machine, the control apparatus comprising:
a manipulation unit determining an operation to be performed by the clothes treating machine or re-determining an operation determined beforehand;
a controller calculating expected power consumption according to the operation determined or re-determined; and
a display unit displaying the expected power consumption or corresponding greenhouse gas emissions or both the expected power consumption and the greenhouse gas emissions.

2. The control apparatus of claim 1, wherein the controller further calculates electricity prices on the basis of the expected power consumption, and
the display unit further displays the electricity prices.

3. The control apparatus of claim 2, wherein controller creates at least one message including energy-saving tips or recommended operation conditions according to operation of the clothes treating machine on the basis of at least one piece of information including the operation, the expected power consumption, the electricity prices, and the greenhouse gas emissions, and
the display unit further displays the message.

4. The control apparatus of claim 3, further comprising a storage unit storing at least one of the operation, the expected power consumption, the electricity prices, the greenhouse gas emissions, and the message.

5. The control apparatus of claim 3, further comprising a communication unit receiving a kind of an energy source generating input power and a greenhouse gas index according to the energy source and sending the message.

6. The control apparatus of claim 1, further comprising:
a sensing unit sensing at least one piece of information including laundry weight, water supply temperature, operating states of loads, and variations of the loads; and
an electric energy detection unit connected to an input power source and detecting supplied power input to the clothes treating machine.

7. A control apparatus of a clothes treating machine, the control apparatus comprising:
a sensing unit sensing at least one piece of information including laundry weight, water supply temperature, operating states of loads, and variations of the loads;
a controller calculating expected power consumption according to the information sensed; and
a display unit displaying the expected power consumption or corresponding greenhouse gas emissions or both the expected power consumption and the corresponding greenhouse gas emissions.

8. The control apparatus of claim 7, wherein the controller further calculates electricity prices on the basis of the expected power consumption, and
the display unit further displays the electricity prices.

9. The control apparatus of claim 8, wherein the controller creates at least one message including energy-saving tips or recommended operation conditions according to operation of the clothes treating machine on the basis of at least one piece of information including the sensed information, the expected power consumption, the electricity prices, and the greenhouse gas emissions, and
the display unit further displays the message.

10. The control apparatus of claim 7, further comprising a manipulation unit determining an operation to be performed by the clothes treating machine or re-determining an operation determined beforehand.

11. The control apparatus of claim 7, further comprising an electric energy detection unit connected to an input power source and detecting supplied power input to the clothes treating machine.

12. The control apparatus of claim 7, wherein the sensing unit comprises:
a speed sensing unit sensing a speed of a motor; and
a thermal mass sensing unit sensing thermal mass of a heater.

13. The control apparatus of claim 12, wherein the controller corrects the expected power consumption on the basis of the variations of the loads.

14. A control apparatus of a clothes treating machine, the control apparatus comprising:
an electric energy detection unit connected to an input power source and detecting supplied power input to the clothes treating machine;
a controller calculating greenhouse gas emissions or electricity prices on the basis of the supplied power; and
a display unit displaying at least one of the supplied power, the greenhouse gas emissions, and the electricity prices.

15. The control apparatus of claim 14, wherein the controller creates at least one message including energy-saving tips or recommended operation conditions according to operation of the clothes treating machine on the basis of at least one piece of information including the supplied power, the electricity prices, and the greenhouse gas emissions, and
the display unit further displays the message.

16. The control apparatus of claim 15, further comprising a storage unit storing at least one of the supplied power, the electricity prices, the greenhouse gas emissions, and the message.

17. The control apparatus of claim 15, further comprising a communication unit receiving a kind of an energy source generating input power and a greenhouse gas index according to the energy source and sending the message.

18. The control apparatus of claim 14, further comprising:
a sensing unit sensing at least one piece of information including laundry weight, water supply temperature, operating states of loads, and variations of the loads; and
a manipulation unit determining an operation to be performed by the clothes treating machine or re-determining an operation determined beforehand.

19. A control method of a clothes treating machine, the control method comprising:
calculating expected power consumption on the basis of an operation to be performed by the clothes treating machine or at least one piece of sensed information including laundry weight, water supply temperature, operating states of loads, and variations of the loads or detecting supplied power input to the clothes treating machine to display the expected power consumption or the supplied power; and
calculating electricity prices or greenhouse gas emissions on the basis of the expected power consumption or the supplied power to further display the electricity prices or the greenhouse gas emissions.

20. The control method of claim 19, further comprising creating at least one message including energy-saving tips or recommended operation conditions according to operation of the clothes treating machine on the basis of at least one of the expected power consumption or the supplied power, the electricity prices, the greenhouse gas emissions, the operation, and the sensed information, and further displaying the message.
